(19) United States
(12) Patent Application Publication
(10) Pub. No.: US 2004/0093514 A1
(43) Pub. Date: May 13, 2004

(54) Method for automatically isolating worm and hacker attacks within a local area network

(75) Inventors: William J. Piazza, Holly Springs, NC (US); Simon C. Chu, Chapel Hill, NC (US); Gregory B. Pruett, Raleigh, NC (US); Steven W. Hunter, Raleigh, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/291,121

(22) Filed: Nov. 8, 2002

(51) Int. Cl. G06F 11/30

(52) U.S. Cl. 713/201

(57) ABSTRACT

In a method for automatically isolating worm software and hacker attacks in a network, a computer system detects, as an attack, a probe by a worm software or a hacker from a compromised computer system in the network. The computer system then isolates the compromised computer system from the remainder of the network. Thus, the probing of the computer system itself is considered an attack. In response to an attack, the compromised computer system is isolated from the remainder of the network. In addition, no dedicated hardware or special hardware is required to implement the method. In this manner, damage to the network by worm software or compromised by a hacker is slowed or prevented by automatically isolating the compromised computer system from the network.

### FIELD OF THE INVENTION

The present invention relates to local area networks, and more particularly to worm and hacker attacks within a local area network.

### BACKGROUND OF THE INVENTION

The problem of attacks from worm software and hackers on computer systems in a network is well known in the art. Such attacks are a major concern of businesses today and a major source of lost revenue.

Worm software may enter a network via email attachments, infected diskettes, and by other means. Hackers typically gain access to a network via a communications channel that was inadvertently left open or has had its security defeated. Although worm and hacker attacks can take many forms, most attacks begin with the act of “probing” the network from an infected system or other access point. The goal of probing is to identify systems that have a known security hole that can be exploited.

A worm software is distinguishable from a virus software in that a worm software attempts to infect other computers using a network medium to exploit known security flaws and weaknesses, whereas a virus propagates itself by modifying executable programs on a single computer. The viruses can spread from system to system with the copying and sending of the infected files to other systems. The neutralization of viruses typically requires prior knowledge of the viruses' signatures or their variant, which enables the detection of the viruses. However, with a worm software or a hacker, the probing itself is an attack. Thus, having prior knowledge of a worm software's signature provides limited protection.

For example, the “Code Red” worm probed IP addresses sequentially by making a particular http request at TCP destination port 80, without knowing whether there was actually a computer system at the address. The characteristics of the http request were such that it included an extremely long URL and the request for a specific web page. If a computer system was present at the target address and if the computer system was running certain versions of Windows IIS web server, a buffer overflow condition would occur. When the buffer overflowed, the last portion of the URL overwrote some executable code and effectively allowed the worm to place its own software on the target system. From the moment that the buffer overflow occurred, the target system was infected and the worm could expand its presence by downloading additional code to the infected system. Eventually, the infected computer system also begins probing the network for more systems to infect.

Accordingly, there exists a need for a method for automatically isolating worm software and hacker attacks in a network. The method should be able to determine that a probe by a worm software or a hacker constitutes an attack, and then take steps to isolate the infected computer system from which the attack is Occurring from the remainder of the network. The present invention addresses such a need.

### SUMMARY OF THE INVENTION

In a method for automatically isolating worm software and hacker attacks in a network, a computer system detects, as an attack, a probe by a worm software or a hacker from a compromised computer system in the network. The computer system then isolates the compromised computer system from the remainder of the network. Thus, the probing of the computer system itself is considered an attack. In response to an attack, the compromised computer system is isolated from the remainder of the network. In addition, no dedicated hardware or special hardware is required to implement the method. In this manner, damage to the network by worm software or compromised by a hacker is slowed or prevented by automatically isolating the compromised computer system from the network.

### BRIEF DESCRIPTION OF THE FIGURES

FIG. 1 illustrates a preferred embodiment of a network implementing the method for automatically isolating worm software and hacker attacks in accordance with the present invention.

FIG. 2 is a flowchart illustrating a preferred embodiment of the method for automatically isolating worm software and hacker attacks in accordance with the present invention.

FIG. 3 illustrates a preferred embodiment of a computer system for detecting a worm software or hacker attack in accordance with the present invention.

### DETAILED DESCRIPTION

The present invention provides a method for automatically isolating worm software and hacker attacks in a network. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

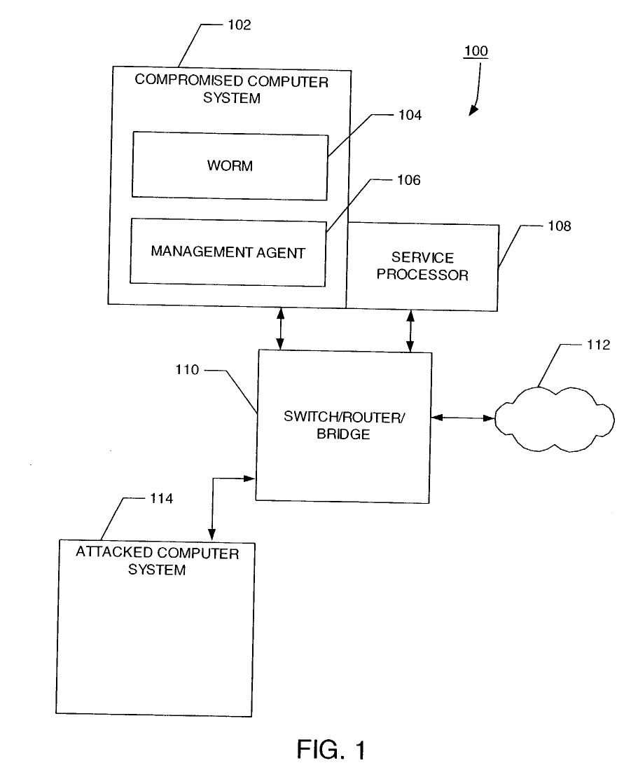

To more particularly describe the features of the present invention, please refer to FIGS. 1 through 3 in conjunction with the discussion below.

FIG. 1 illustrates a preferred embodiment of a network implementing the method for automatically isolating worm software and hacker attacks in accordance with the present invention. The network 100 comprises a compromised computer system 102, infected with a worm software 104 or is a tool of attack by a hacker. The compromised computer system 102 comprises a management agent 106 and/or a service processor 108. The compromised computer system 102 sends packets to other computer systems in the network 100 through a switch, router, or a bridge 110. In the preferred embodiment, the management agent 106 is a software running on a computer system in the network 100. It monitors the computer system and notifies the appropriate network administrators when a problem is detected. The management agent 106 may have the ability to perform corrective actions as well. Some remote access to the management agent 106 may be allowed. The service processor 108 is a hardware separate from a computer system. It monitors the network 100 and notifies the appropriate network administrators when a problem is detected. The service processor 108 may also have the ability to perform corrective actions.

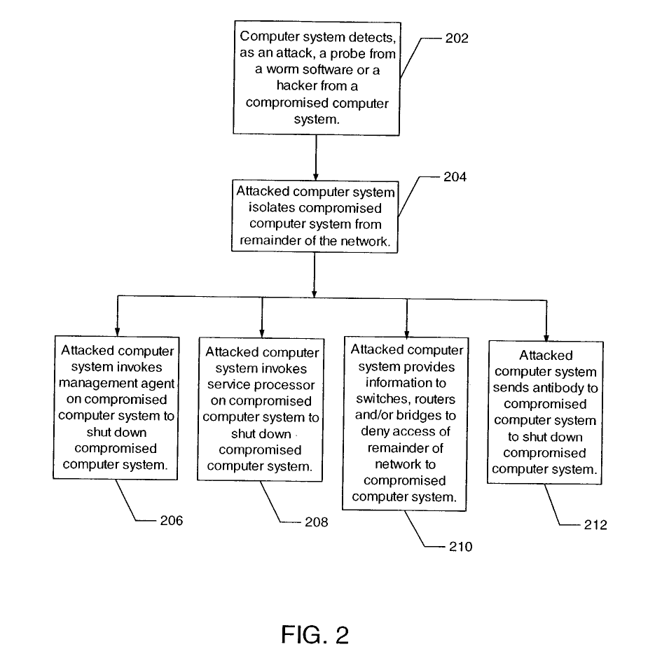

FIG. 2 is a flowchart illustrating a preferred embodiment of the method for automatically isolating worm software and hacker attacks in accordance with the present invention. First, a computer system 114 detects, as an attack, a probe by a worm software or hacker from a compromised computer system 102, via step 202. The attacked computer system 114 then isolates the compromised computer system from the remainder of the network 112, via step 204.

In the preferred embodiment, the isolation can be accomplished in one of four ways. In the first way, the attacked computer system 114 invokes the management agent 106 on the compromise computer system 102 to shut down the compromised computer system 102, via step 206. This step would not work if the worm software 104 has disabled the ability of the management agent 106 to operate normally, but it would be effective against an attack by a hacker.

In the second way, the attacked computer system 114 invokes a service processor 108 of the compromised computer system 102 to shut down the compromised computer system 102, via step 208. This step is applicable to servers and would isolate the compromised computer system 102 regardless of the effects that the infection has had on the compromised server system.

In the third way, the attacked computer system 114 provides information to the switch, router, and/or bridge 110 to deny access of the remainder of the network 112 to the compromised computer system 102, via step 210. The attacked computer system 114 sends the necessary information about the compromised computer system 102 to a management interface (not shown) within the switch, router, or bridge 110. Based on this information, the switch, router, or bridge 110 updates its filtering function so that any messages from the compromised computer system 102 are filtered out at the input port of the networking device. Alternatively, the switch, router, or bridge 110 updates its forwarding tables so that any messages received from the compromised computer system 102 are discarded.

In the fourth way, the attacked computer system 114 identifies the weaknesses that the worm software 104 is known to have and uses them create a non-replicating variation of the worm software 104 designed to shut down the compromised computer system 102.

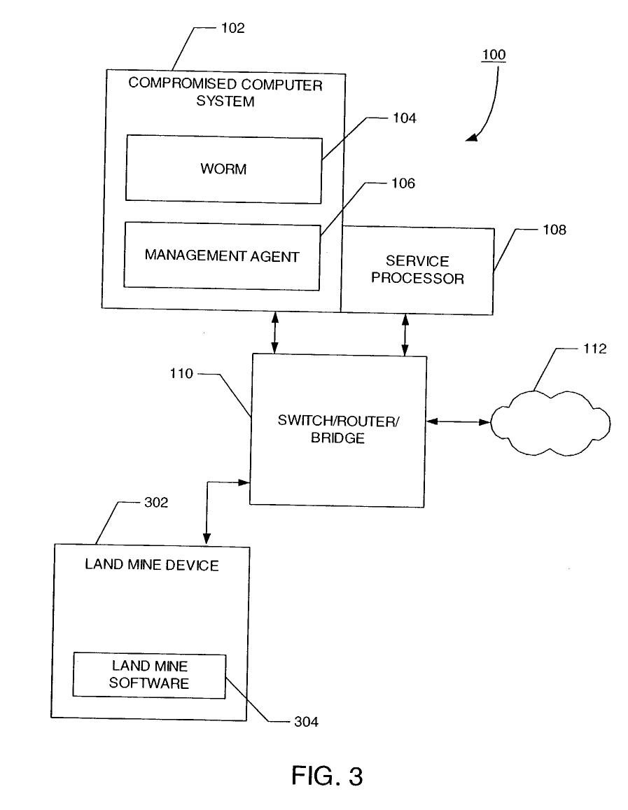

FIG. 3 illustrates a preferred embodiment of a computer system for detecting a worm software or hacker attack in accordance with the present invention. In the preferred embodiment, the computer system 114 is a “land mine” device 302. The land mine device 302 can be an ordinary desktop computer, a server, a mobile computer, or some other type of device comprising the land mine software 304. The land mine device 302 also comprises a network interface 306 through which it communicates with the rest of the network 100, and a processor 308 which executes the program instructions of the land mine software 304. The land mine device 302 exposes itself to the same type of probing that a worm software or a hacker may initiate on the other computer systems in the network 100 through its network interface 306. However, unlike the other computer systems, the land mine device 302 does not include any useful network services. Thus, the land mine device 302 has very little reason to be addressed on the network 100 at all. Therefore, any messages addressed to the land mine device 302 are potentially signatures of an attack and are treated as such. Optionally, the land mine device 302 may ignore certain probes if they are known to come from systems performing management functions that legitimately involve probing the network. Once an attack is detected by the land mine software 304, the compromised computer system 102 from which the probe is sent is identified. The land mine software 304 then isolates the compromised computer system 102 in the manner described above.

Although the present invention is described above with this method of detecting an attack, other detecting methods can be used without departing from the spirit and scope of the present invention.

Because the probing of the computer system 114 itself is considered an attack, worm signatures resident on the computer system 114 is not required to detect the attack. In addition, no dedicated hardware or special hardware is required to implement the method. In response to an attack, the compromised computer system 102 is isolated without regard to the data the system 102 sends out and without any need to modify data files. In this manner, damage to the network 100 by worm software or hacker attacks is slowed or prevented by effectively automatically removing the compromised computer system from the network 100.

Optionally, once an attack is detected, the land mine software 304 can send out notifications of such an attack to other computer systems in the network 100. These other computer systems can then initiate an update of their respective antivirus software for worm signatures. They may further invoke the antivirus software to check for worm signatures and disable the worm software.

A method for automatically isolating worm software and hacker attacks in a network has been disclosed. In the method, a computer system detects, as an attack, a probe by a worm software or a hacker from a compromised computer system in the network. The computer system then isolates the compromised computer system from the remainder of the network. Thus, the probing of the computer system itself is considered an attack. In response to an attack, the compromised computer system is isolated from the remainder of the network. In addition, no dedicated hardware or special hardware is required to implement the method. In this manner, damage to the network by worm software or is compromised by a hacker is slowed or prevented by automatically isolating the compromised computer system from the network.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for automatically isolating a worm software or hacker attack in a network, the network including a plurality of computer systems, comprising the steps of:
(a) detecting as an attack a probe by the worm software or the hacker from a compromised computer system; and
(b) isolating the compromised computer system from a remainder of the network.

2. The method of claim 1, wherein the isolating step (b) comprises:
(b1) invoking a management agent on the compromised computer system to shut down the compromised computer system.

3. The method of claim 1, wherein the isolating step (b) comprises:
(b1) invoking a service processor on the compromised computer system to shut down the compromised computer system.

4. The method of claim 1, wherein the isolating step (b) comprises:
(b1) providing information to a switch, router, or bridge to deny access of the remainder of the network to the compromised computer system.

5. The method of claim 1, wherein the isolating step (b) comprises:
(b1) sending an antibody for the worm software to the compromised computer system to shut down the compromised computer system.

6. The method of claim 1, wherein the detecting step (a) comprises:
(a1) receiving a probe by a device, wherein the device includes no useful network services;
(a2) detecting the probe as an attack by the worm software or the hacker; and
(a3) identifying the compromised computer system from which the probe was sent.

7. A computer network, comprising:
a first computer system;
a routing device coupled to the first computer system; and
a second computer system coupled to the routing device, wherein the second computer system detects a probe from the first computer system as an attack, wherein the second computer system then isolates the first computer system from a remainder of the network.

8. The network of claim 7, wherein the first computer system comprises a worm software, wherein the second computer system sends an antibody for the worm software to the first computer system to shut down the first computer system.

9. The network of claim 7, wherein the routing device comprises one or more of a group consisting of:
a switch;
a router; and
a bridge.

10. The network of claim 7, wherein the first computer system comprises a management agent, wherein the second computer system invokes the management agent to shut down the first computer system.

11. The network of claim 7, further comprising a service processor coupled to the first computer system, wherein the second computer system invokes the service processor to shut down the first computer system.

12. The network of claim 7, wherein the second computer system provides information to the routing device to deny access of the remainder of the network to the first computer system.

13. The network of claim 7, wherein the second computer system provides no useful network services.

14. A computer readable medium with program instructions for automatically isolating a worm software or hacker attack in a network, comprising the instructions for:
(a) detecting as an attack a probe by the worm software or the hacker from a compromised computer system; and
(b) isolating the compromised computer system from a remainder of the network.

15. The medium of claim 14, wherein the isolating instruction (b) comprises:
(b1) invoking a management agent on the compromised computer system to shut down the compromised computer system.

16. The medium of claim 14, wherein the isolating instruction (b) comprises:
(b1) invoking a service processor on the compromised computer system to shut down the compromised computer system.

17. The medium of claim 14, wherein the isolating instruction (b) comprises:
(b1) providing information to a switch, router, or bridge to deny access of the remainder of the network to the compromised computer system.

18. The medium of claim 14, wherein the isolating instruction (b) comprises:
(b1) sending an antibody for the worm software to the compromised computer system to shut down the compromised computer system.

19. The medium of claim 14, wherein the detecting instruction (a) comprises:
(a1) receiving a probe by a device, wherein the device includes 110 useful network services;
(a2) detecting the probe as an attack by the worm software or the hacker; and
(a3) identifying the compromised computer system from which the probe was sent.

20. A computer system, comprising:
a network interface for communicating with a plurality of devices on a network; and
a processor, wherein the processor is capable of executing program instructions, comprising program instructions for:
detecting as an attack a probe by a worm software or a hacker from a compromised computer system, and
isolating the compromised computer system from a remainder of the network.

21. The system of claim 20, wherein the isolating instruction comprises:
invoking a management agent on the compromised computer system to shut down the compromised computer system.

22. The system of claim 21, wherein the isolating instruction comprises:
invoking a service processor on the compromised computer system to shut down the compromised computer system.

23. The system of claim 20, wherein the isolating instruction comprises:
providing information to a switch, router, or bridge to deny access of the remainder of the network to the compromised computer system.

24. The system of claim 20, wherein the isolating instruction comprises:
sending an antibody for the worm software to the compromised computer system to shut down the compromised computer system.

25. The system of claim 20, wherein the detecting instruction comprises:
receiving a probe by a device, wherein the device includes no useful network services;
detecting the probe as an attack by the worm software or the hacker; and
identifying the compromised computer system from which the probe was sent.
